(19) United States
(12) Patent Application Publication
(10) Pub. No.: US 2026/0227261 A1
(43) Pub. Date: Aug. 6, 2026

(54) ELECTRONIC DEVICE COMPRISING BAROMETRIC PRESSURE SENSOR, AND BAROMETRIC PRESSURE SENSOR DATA CALIBRATION METHOD THEREFOR

(71) Applicant: SAMSUNG ELECTRONICS CO., LTD., Suwon-si (KR)

(72) Inventors: Hyeonseong KIM, Suwon-si (KR); Minkyung HWANG, Suwon-si (KR)

(73) Assignee: SAMSUNG ELECTRONICS CO., LTD., Suwon-si (KR)

(21) Appl. No.: 19/564,882

(22) Filed: Mar. 12, 2026

Related U.S. Application Data
(63) Continuation of application No. PCT/KR2024/014511, filed on Sep. 25, 2024.

(30) Foreign Application Priority Data
Sep. 26, 2023 (KR) 10-2023-0129497
Nov. 13, 2023 (KR) 10-2023-0156229

(51) Int. Cl. G01L 27/00; G01D 18/00; G01L 19/00; G01L 19/02; G01L 19/08; G01L 19/14; G01P 15/14; G01P 15/18; G01W 1/18

(52) U.S. Cl. CPC G01L 27/002; G01L 19/0092; G01L 19/02; G01L 19/083; G01L 19/147; G01P 15/14; G01P 15/18; G01W 1/18; G01D 18/006

(57) ABSTRACT

An electronic device may include an inertial sensor, a barometric pressure sensor, a memory for storing executable instructions, and a processor for executing the instructions by accessing the memory. The electronic device may store, in the memory, a barometric pressure offset estimation model according to a positioning characteristic, acquire a barometric pressure sensor signal from the barometric pressure sensor, acquire an inertial sensor signal from the inertial sensor, if a fall or impact event is detected on the basis of the inertial sensor signal, identify a first section in which there is no movement of the electronic device in the inertial sensor signal before the fall or impact event is detected, and remodel the barometric pressure offset estimation model stored in the memory on the basis of reference barometric pressure and reference acceleration extracted from the first section.

### CROSS-REFERENCE TO RELATED APPLICATIONS

This is a continuation application of International Patent Application No. PCT/KR2024/014511, filed on Sep. 25, 2024, which claims priority to Korean Patent Application No. 10-2023-0129497, filed on Sep. 26, 2023, and Korean Patent Application No. 10-2023-0156229, filed on Nov. 13, 2023, in the Korean Intellectual Property Office, the disclosures of which are incorporated herein by reference in their entireties.

### BACKGROUND

The disclosure relates to an electronic device including a barometric pressure sensor and a barometric pressure sensor data calibration method.

An electronic device may include sensors that detect (or measure) various types of information (or data), and may provide various related services (e.g., health management) based on the sensing data acquired from the sensors. For example, the electronic device may include a barometric pressure sensor. The barometric pressure sensor may measure the flow of air introduced through a hole exposed to the outside of the electronic device to measure the barometric pressure.

In addition, among the functional elements of an electronic device, the waterproof function may be an essential function for using the electronic device (e.g., a wearable electronic device) in water, such as for swimming.

In the case of a barometric pressure sensor, there is a hole that is exposed to the outside of the electronic device in order to drive the barometric pressure sensor, and thus, the barometric pressure sensor is implemented in a form where a waterproof gel is applied to the sensing part to ensure a waterproofing function.

However, a barometric pressure sensor with a waterproof function (hereinafter, a waterproof barometric pressure sensor) may experience changes in gravitational effects due to the attitude angle (or tilt angle) of the electronic device caused by the application of a waterproof gel, which may result in barometric pressure sensor errors. The barometric pressure sensor errors caused by the application of the waterproof gel tend to increase as the attitude or tilt angle of the electronic device increases.

Barometric pressure sensor errors may cause misidentification of a fall situation in a fall detection algorithm or may cause malfunctions in an algorithm for predicting a user's altitude.

Additionally, the barometric pressure sensor errors caused by gravitational effects due to waterproof gel application are difficult to precisely calibrate in hardware, thus, solutions to compensate for or mitigate these errors may be required.

The above-described information may be provided as related art for the purpose of aiding in the understanding of the disclosure. No contention or determination is made as to whether any of the above descriptions may be applied as prior art related to the disclosure.

### SUMMARY

According to various embodiments, when implementing a barometric pressure sensor with a waterproof function, the barometric pressure sensor may be more accurately calibrated by remodeling a barometric pressure offset estimation model and predicting a barometric pressure correction value each time an impact or fall event occurs.

The technical problems to be addressed by the disclosure are not limited to the above-described technical problems, and other technical problems not mentioned herein will be clearly understood by those skilled in the art from the following description. However, the problems to be solved by the disclosure are not limited to the above-mentioned problems, and may be variously extended without the spirit and scope of the disclosure.

An electronic device according to an embodiment may include an inertial sensor. The electronic device according to an embodiment may include a barometric pressure sensor. The electronic device according to an embodiment may include a memory configured to store executable instructions and a processor configured to access the memory and execute the instructions. The processor according to an embodiment may be configured to store, in the memory, a barometric pressure offset estimation model according to posture characteristics of the electronic device. The processor according to an embodiment may be configured to acquire a barometric pressure sensor signal from the barometric pressure sensor. The processor according to an embodiment may be configured to acquire an inertial sensor signal from the inertial sensor. The processor according to an embodiment may be configured to, in case that a fall or impact event is detected based on the inertial sensor signal, identify a first segment in which there is no motion of the electronic device in an inertial sensor signal before the detection of the fall or impact event. The processor according to an embodiment may be configured to remodel a barometric pressure offset estimation model stored in the memory, based on a reference barometric pressure and reference acceleration extracted from the first segment. The processor according to an embodiment may be configured to identify a second segment in which there is no motion of the electronic device in an inertial sensor signal after the detection of the fall or impact event. The processor according to an embodiment may be configured to estimate a barometric pressure correction value of the barometric pressure sensor by applying barometric pressure and acceleration extracted from the identified second segment as input values to the remodeled barometric pressure offset estimation model. The processor according to an embodiment may be configured to acquire calibrated barometric pressure data by reflecting the barometric pressure correction value in a barometric pressure sensor signal after the detection of the fall or impact event.

A barometric pressure sensor data calibration method of an electronic device including a barometric pressure sensor, according to an embodiment, may include storing, in a memory, a barometric pressure offset estimation model according to posture characteristics of the electronic device. The barometric pressure sensor data calibration method according to an embodiment may include acquiring a barometric pressure sensor signal from the barometric pressure sensor and acquiring an inertial sensor signal from an inertial sensor. The barometric pressure sensor data calibration method according to an embodiment may include, in case that a fall or impact event is detected based on the inertial sensor signal, identifying a first segment in which there is no motion of the electronic device in an inertial sensor signal before the detection of the fall or impact event. The barometric pressure sensor data calibration method according to an embodiment may include remodeling the barometric pressure offset estimation model stored in the memory, based on reference barometric pressure and reference acceleration extracted from the first segment. The barometric pressure sensor data calibration method according to an embodiment may include identifying a second segment in which there is no motion of the electronic device in an inertial sensor signal after the detection of the fall or impact event. The barometric pressure sensor data calibration method according to an embodiment may include estimating a barometric pressure correction value of the barometric pressure sensor by applying barometric pressure and acceleration extracted from the identified second segment as input values to the remodeled barometric pressure offset estimation model. The barometric pressure sensor data calibration method according to an embodiment may further include acquiring calibrated barometric pressure data by reflecting the barometric pressure correction value in a barometric pressure sensor signal after the detection of the fall or impact event.

The electronic device of the disclosure may include a computer-readable recording medium in which a program for implementing a method for calibrating a barometric pressure sensor employing a waterproof function is recorded.

A computer-readable recording medium recording a computer program for executing a barometric pressure sensor data calibration method of an electronic device including a barometric pressure sensor, according to an embodiment, may include an operation of storing, in the memory, a barometric pressure offset estimation model according to posture characteristics of the electronic device, an operation of acquiring a barometric pressure sensor signal from the barometric pressure sensor, an operation of acquiring an inertial sensor signal from an inertial sensor, an operation of identifying, in case that a fall or impact event is detected based on the inertial sensor signal, a first segment in which there is no motion of the electronic device in an inertial sensor signal before the detection of the fall or impact event, an operation of remodeling the barometric pressure offset estimation model stored in the memory, based on reference barometric pressure and reference acceleration extracted from the first segment, an operation of identifying a second segment in which there is no motion of the electronic device in an inertial sensor signal after the detection of the fall or impact event, an operation of estimating a barometric pressure correction value of the barometric pressure sensor by applying barometric pressure and acceleration extracted from the identified second segment as input values to the remodeled barometric pressure offset estimation model, and an operation of acquiring calibrated barometric pressure data by reflecting the barometric pressure correction value in a barometric pressure sensor signal after the detection of the fall or impact event.

In one or more embodiments, an electronic apparatus may include: a motion sensor configured to generate motion data; a waterproof pressure sensor configured to generate atmospheric pressure data; a memory storing a pressure offset estimation model associated with orientations of the electronic apparatus; and a processor communicatively coupled to the memory, the motion sensor, and the waterproof pressure sensor, wherein the processor is configured to: monitor the motion data to detect a trigger event representing a physical impact; determine a pre-event stationary window from the motion data occurring prior to the trigger event; update the pressure offset estimation model stored in the memory based on a baseline pressure value and a baseline orientation value obtained from the pre-event stationary window; determine a post-event stationary window from the motion data occurring after the trigger event; calculate a correction factor by inputting pressure and orientation values obtained from the post-event stationary window into the updated pressure offset estimation model; and generate compensated pressure information by applying the correction factor to pressure data captured subsequent to the trigger event.

The electronic device, the method, and the recording medium according to various embodiments may calibrate the barometric pressure sensor based on impact or fall situations to predict a more accurate barometric pressure correction value, thereby reducing barometric pressure sensor errors caused by waterproof gel application.

The electronic device, the method, and the recording medium according to various embodiments may reduce barometric pressure sensor errors caused by a waterproof gel, thereby preventing malfunctions caused by a fall detection algorithm or an altitude measurement algorithm.

The effects obtainable from the disclosure are not limited to the above-mentioned effects, and other effects not mentioned herein will be clearly understood by those skilled in the art to which the disclosure belongs from the following description.

### BRIEF DESCRIPTION OF DRAWINGS

In the following description of the drawings, identical or similar reference numerals may be used to denote identical or similar elements.

FIG. 1 is a block diagram illustrating an electronic device 101 in a network environment 100 according to various embodiments.

FIG. 2A is a schematic diagram illustrating an example of the configuration of an electronic device according to an embodiment.

FIG. 2B is a diagram illustrating an example of the structure of a waterproof barometric pressure sensor according to an embodiment.

FIG. 3 illustrates a barometric pressure sensor data calibration method for an electronic device according to an embodiment.

FIG. 4 illustrates graphs of an inertial sensor and a barometric pressure sensor of an electronic device according to an embodiment.

FIG. 5 illustrates a method for modeling a barometric pressure offset estimation model for an electronic device according to an embodiment.

FIG. 6 illustrates a barometric pressure sensor data calibration method for an electronic device according to an embodiment.

FIG. 7 illustrates a user interface screen related to barometric pressure sensor calibration in an electronic device according to an embodiment.

FIGS. 8 to 10 illustrate graphs of inertial sensor and barometric pressure sensor signals in various event situations according to various embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

In the present disclosure, the term “an embodiment” is intended to encompass one or more embodiments, rather than being limited to a single example. Furthermore, features described in embodiments may be combined and implemented together.

An electronic device according to an embodiment disclosed herein may be a device of various types. The electronic device may include, for example, a portable communication device (e.g., a smartphone), a computer device, a portable multimedia device, a portable medical device, a camera, a wearable device, or a home appliance. The electronic device according to the disclosure is not limited to the above-described devices.

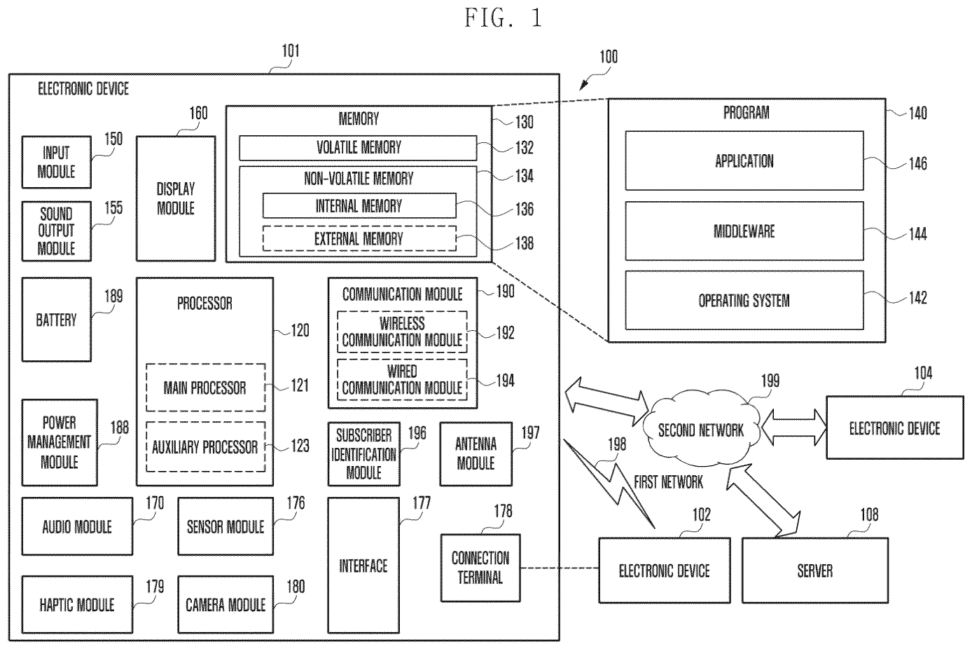

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

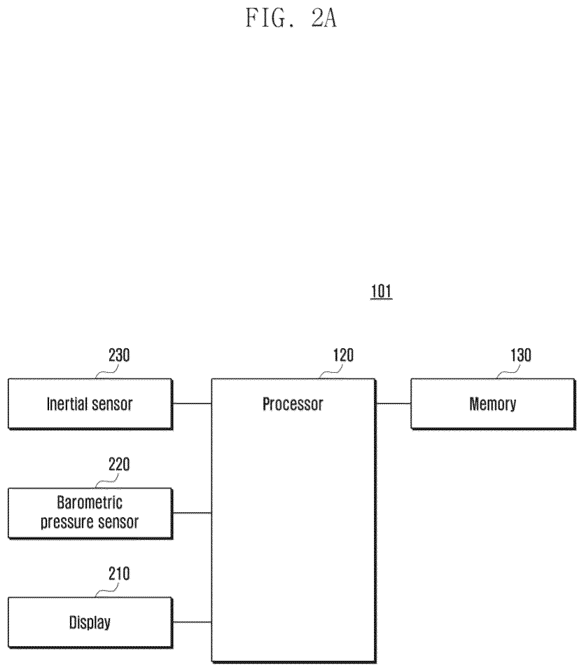

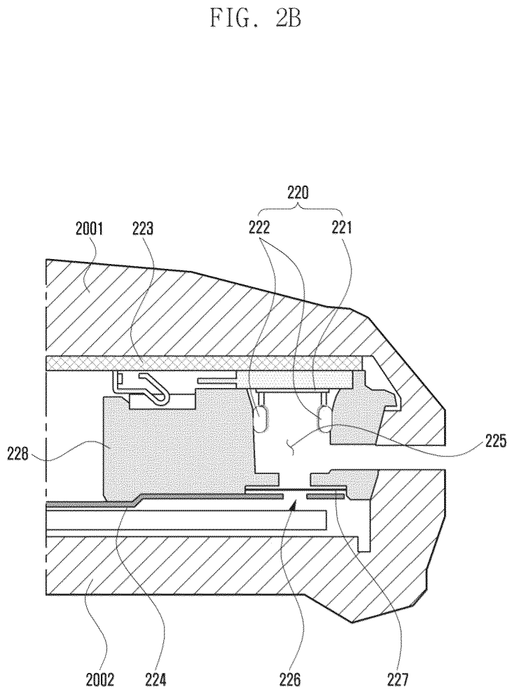

FIG. 2A is a schematic diagram illustrating an example of the configuration of an electronic device according to an embodiment, and FIG. 2B is a diagram illustrating an example of the structure of a waterproof barometric pressure sensor according to an embodiment.

Referring to FIG. 2A, an electronic device 101 according to an embodiment may include a display 210 (e.g., the display module 160), a barometric pressure sensor 220 (e.g., the sensor module 176 of FIG. 1), an inertial sensor 230 (e.g., the sensor module 176 of FIG. 1), a processor 120, and a memory 130. While certain embodiments may describe the inertial sensor 230 as an example of a motion sensor to facilitate the explanation of specific tilt and impact detection, the implementation of the electronic device 101 is not limited thereto. Any type of motion sensor capable of detecting movement, orientation, or environmental displacement of the electronic device 101 may be utilized instead of, or in addition to, the inertial sensor 230. Such motion sensors may operate by converting physical stimuli, such as mechanical force, electromagnetic waves, or thermal energy, into measurable electrical signals (e.g., motion data). The motion sensor may include one or a combination of inertial measurement Units (IMU) (e.g., accelerometers for measuring linear acceleration and gyroscopes for measuring angular velocity), optical sensors (e.g., infrared (IR) sensors, time-of-flight (ToF) sensors, or image-based sensors that detect spatial changes), and geomagnetic sensors.

The electronic device 101 according to an embodiment may be a device wearable on a user's body, such as a wearable electronic device, but is not limited thereto.

The display 210 may correspond to the display module illustrated in FIG. 1. Under the control of the processor 120, the display 210 may visually provide various types of result information obtained by processing various types of information (e.g., user interface screens) and/or sensing data (e.g., barometric pressure data and/or inertial data) related to the barometric pressure sensor 220 or the inertial sensor 230.

The barometric pressure sensor 220 may detect a change in barometric pressure through a hole exposed to the outside of the electronic device 101, convert the barometric pressure change into a digital signal (hereinafter, barometric pressure data), and transmit the barometric pressure data to the processor 120. The processor 120 may acquire the barometric pressure data from the barometric pressure sensor 220 and store the barometric pressure data in the memory 130.

According to an embodiment, the barometric pressure sensor 220 may be implemented as a waterproof barometric pressure sensor including a waterproof structure (e.g., a waterproof gel or a waterproof member) and configured to generate atmospheric pressure data. The barometric pressure sensor 220 may be formed, for example, in the structure illustrated in FIG. 2B. FIG. 2B illustrates only an example of the barometric pressure sensor 220 including a waterproof structure, and the disclosure is not limited thereto. The barometric pressure sensor 220 may be disposed in the space between a first housing 2001 and a second housing 2002. The barometric pressure sensor 220 may include a flexible substrate 221 and a sealing structure 222. The sealing structure 222 may be configured to be in close contact with the inner wall of a bracket 228 so as to seal the space between the inner wall of the bracket 228 and the barometric pressure sensor 220. In some cases, a waterproof gel may also be applied toward the flexible substrate 221 and the sealing structure 222. The bracket 228 may support components (e.g., a circuit board 223, a support plate 224, a battery, the display, and the like) mounted in the electronic device 101. A portion of the bracket 228 may be formed to have a structure including a duct for introducing external air into an opening area 225 through a hole. The circuit board 223 may have electronic components such as the processor 120, the memory 130, the communication module 190, an interface, or a connection terminal disposed thereon. The barometric pressure sensor 220 may be electrically connected to the circuit board 223 and may transmit barometric pressure data to the processor 120 disposed on the circuit board 223. The processor 120 may also determine whether the electronic device 101 is submerged, based on a barometric pressure change equal to or greater than a predetermined value measured by the barometric pressure sensor 220. A waterproof member 227 may be disposed between the bracket 228 and the support plate 224. The waterproof member 227 may prevent water introduced into the opening area 225 from the outside through the hole from entering the inner space 226 of the electronic device 101.

The inertial sensor 230 may detect a change in motion according to the posture of the electronic device 101, convert a motion change signal into a digital signal (hereinafter, inertial data), and transmit the inertial data to the processor 120. The inertial data may include acceleration data and gyro data, but is not limited thereto. The processor 120 may acquire the inertial data (e.g., acceleration data, gyro data) from the inertial sensor 230 and store the inertial data in the memory 130.

According to an embodiment, the inertial sensor 230 may include various types of sensors for measuring angular velocity and linear acceleration. The inertial sensor 230 may include at least one of a 3-axis accelerometer, a gyroscope, a magnetometer sensor, a tilt sensor, a motion sensor, and/or an inertial measurement device. For example, the inertial sensor 230 may extract angle information such as pitch, roll, and yaw by using a gyro sensor, and track a velocity direction (e.g., jumping, movement speed) by using an acceleration sensor. In some cases, when the inertial sensor 230 includes a geomagnetic sensor, the geomagnetic sensor may be used to track the Earth's magnetic field value to track the direction of motion.

The memory 130 may store various instructions which may be executed by the processor 120. The instructions may include control commands such as arithmetic and logical operations, data movement, or input/output, which can be recognized by the processor 120.

The processor 120 may control the operation of the display 210, the barometric pressure sensor 220, and/or the inertial sensor 230, and may control the operation of a barometric pressure sensor calibration algorithm (or program, process) by using sensing data (e.g., barometric pressure data, inertial data) acquired from the barometric pressure sensor 220 and/or the inertial sensor 230.

The computational and data-processing functions that the processor 120 may implement on the electronic device 101 are not limited, but the following describes barometric pressure sensor calibration operations in which the processor determines the timing (or conditions) for remodeling a barometric pressure offset estimation model based on inertial data, and remodels the barometric pressure offset estimation model to reduce the barometric pressure sensor error range. The operations of the processor 120 described below may be performed by loading the instructions stored in the memory 130.

An electronic device 101 according to an embodiment may include an inertial sensor 230, a barometric pressure sensor 220, a memory 130 configured to store executable instructions, and a processor 120 configured to access the memory 130 and execute the instructions. The processor 120 may be configured to: store, in the memory 130, a barometric pressure offset estimation model according to the posture characteristics of the electronic device; acquire a barometric pressure sensor signal from the barometric pressure sensor; acquire an inertial sensor signal from the inertial sensor; when a fall or impact event is detected based on the inertial sensor signal, identify a first segment in an inertial sensor signal before the fall or impact event detection, in which there is no motion of the electronic device; remodel the barometric pressure offset estimation model stored in the memory, based on reference barometric pressure and reference acceleration extracted from the first segment; identify a second segment in an inertial sensor signal after the fall or impact event detection, in which there is no motion of the electronic device; estimate a barometric pressure correction value of the barometric pressure sensor by applying barometric pressure and acceleration extracted from the identified second segment as input values to the remodeled barometric pressure offset estimation model; and acquire calibrated barometric pressure data by reflecting the barometric pressure correction value in a barometric pressure sensor signal after the fall or impact event detection.

The barometric pressure sensor according to an embodiment may be a waterproof barometric pressure sensor having a sensing portion to which a waterproof gel is applied.

The processor 120 according to an embodiment may be further configured to detect a fall or impact event occurrence situation when the inertial sensor signal exceeds a predetermined threshold value or when an impact at or above a predetermined level occurs.

The inertial sensor data according to an embodiment may include a 3-axis acceleration signal and a gyro signal.

According to an embodiment, the processor 120 may be further configured to determine that a segment in which a signal vector magnitude (SVM) signal of the 3-axis acceleration signal and the gyro signal are included within a predetermined threshold range for a predetermined time, or a segment in which a signal variation exists within an error range for a predetermined time, is the first segment in which there is no motion of the electronic device. For example, the processor 120 may monitor motion data provided from the inertial sensor 230, detect a trigger event representing a physical impact, and determine a pre-event stationary window from the motion data occurring prior to the trigger event. In determining the pre-event stationary window, the processor 120 may identify the pre-event stationary window by detecting a period where the SVM and the gyro signal remain within a predefined threshold for a specific duration, and may calculate a baseline pressure value (e.g., a reference barometric pressure) and a baseline orientation value (e.g., a reference acceleration value) by extracting representative statistical values from the gyro signal captured during the pre-event stationary window.

According to an embodiment, the processor 120 may be further configured to extract a representative value of barometric pressure sensor signals and a representative value of acceleration signals within the first segment as the reference barometric pressure and the reference acceleration, respectively.

According to an embodiment, the processor 120 may be configured to apply a low-pass filter (LPF) to the acquired barometric pressure sensor signal to smooth the signal, and extract the representative value of the barometric pressure sensor signals, based on the smoothed barometric pressure sensor signal.

According to an embodiment, the processor 120 may be configured to: repeatedly collect acceleration and barometric pressure data for each posture of the electronic device, then calculate a model between the collected independent and dependent variables, and measure and analyze the fitness to model the barometric pressure offset estimation model; and store the modeled barometric pressure offset estimation model in the memory.

According to an embodiment, the processor 120 may be configured to remodel the barometric pressure offset estimation model each time the fall or impact event is detected.

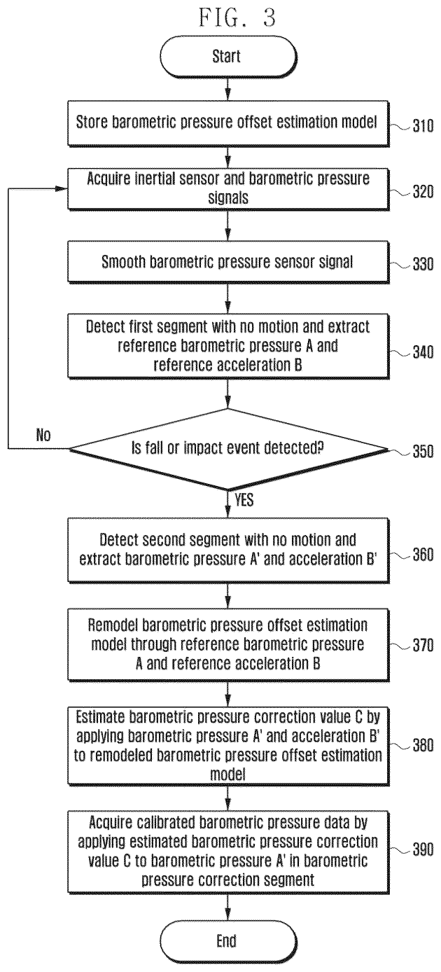

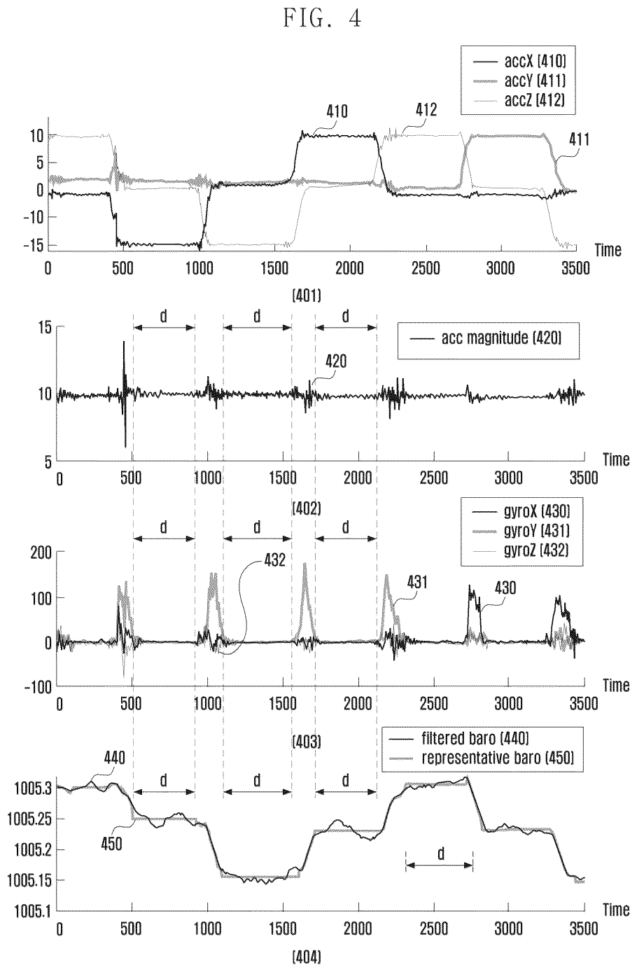

FIG. 3 illustrates a barometric pressure sensor data calibration method for an electronic device according to an embodiment, and FIG. 4 illustrates graphs of inertial sensor and barometric pressure sensor signals of an electronic device according to an embodiment.

In the following embodiments, operations may be performed sequentially, but are not necessarily performed sequentially. For example, the order of the operations may be changed, and at least two operations may be performed in parallel.

Referring to FIG. 3, in operation 310, the processor 120 of the electronic device 101 according to an embodiment may store a barometric pressure offset estimation model in the memory 130. The barometric pressure offset estimation model may be generated by repeatedly collecting acceleration and barometric pressure data for each posture of the electronic device 101 during the manufacturing of the electronic device 101, and analyzing and modeling the collected data.

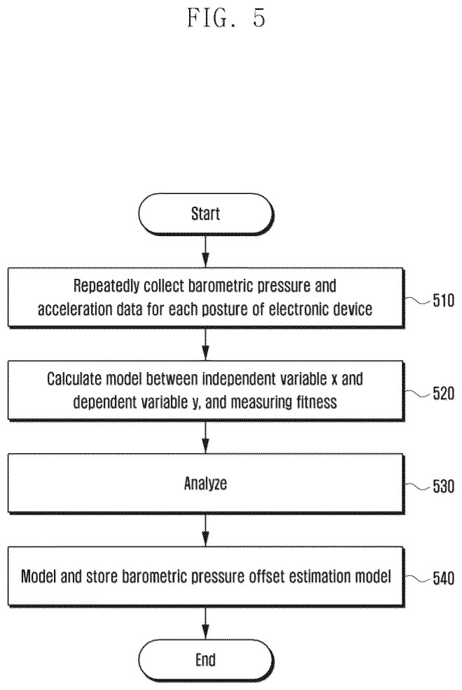

The barometric pressure offset estimation model may receive barometric pressure and acceleration signals and predict (or output, acquire) a barometric pressure correction value by using a mathematical expression that obtains a parameter for minimizing the barometric pressure error. The modeling operation of the barometric pressure offset estimation model will be described with reference to FIG. 5.

In operation 320, the processor 120 may acquire a barometric pressure sensor signal from the barometric pressure sensor 220 and acquire an inertial sensor signal from the inertial sensor 230. The inertial sensor signal may include an acceleration signal and a gyro signal.

For example, FIG. 4 may be a diagram illustrating graphs of an inertial sensor signal and a barometric pressure sensor signal when the electronic device is rotated about the x-axis and the y-axis in a posture in which the front surface of the electronic device faces the sky. Graph 401 in FIG. 4 is a 3-axis acceleration sensor graph, and may indicate changes in an x-axis acceleration signal 410, a y-axis acceleration signal 411, and a z-axis acceleration signal 412 according to the posture of the electronic device 101. In Graph 401, the Y-axis may indicate a strength and a direction of a detected movement of the electronic device 101, wherein positive values may show movement or gravitational pull in a forward or up direction of a specific axis, negative values may show movement or pull in a backward“ or down” direction of a specific axis, and a zero indicates that the electronic device 101 is either still or moving at a constant speed with no vibration.

Graph 403 in FIG. 4 is a gyro sensor graph, and may indicate a change in a gyro signal 430 according to the posture of the electronic device 101. Graph 402 in FIG. 4 is a graph of a signal of the magnitude of the sum ((hereinafter, signal vector magnitude (SVM)) of a 3-axis acceleration signals, and Graph 404 in FIG. 4 is a barometric pressure graph.

In operation 330, the processor 120 may use a smoothing filter to smooth the barometric pressure sensor signal and remove noise. The smoothing filter may use a low-pass filter (LPF) and a digital filter, but is not limited thereto.

In the case of a barometric pressure sensor signal, due to the characteristics of the sensor, a minute change (or error) may occur even in a segment in which there is no motion of the electronic device, and therefore, the electronic device 101 may generate a smoothed signal by using a smoothing filter. For example, a part of Graph 404 in FIG. 4 is a barometric pressure sensor graph, and shows the change of a signal 440 smoothed according to the posture of the electronic device 101.

According to an embodiment, operation 330 may be omitted. For example, when the noise error level in the barometric pressure sensor signal is low (or when the barometric pressure sensor performance is good), the operation 330 may be omitted.

In operation 340, the processor 120 may detect (or determine or identify) a first segment d in which there is no motion of the electronic device, based on the inertial sensor signal, and extract reference barometric pressure A and reference acceleration B information in the first segment d. For convenience of description, the first segment d is illustrated in Graph 404, but the first segment may be the same in Graphs 401, 402, and 403 as well.

According to an embodiment, the processor 120 may calculate a signal vector magnitude (SVM) value for the collected 3-axis (e.g., x-axis, y-axis, z-axis) acceleration signals, and may detect the first segment d by analyzing an SVM signal and a gyro signal. The SVM value may refer to a value used to process the output value of the 3-axis acceleration sensor as a single representative value without considering rotational components included in the output value.

For example, Graph 402 in FIG. 4 is an acceleration SVM graph and may represent the change in an SVM signal 420, which indicates the magnitude change of the sum of the 3-axis acceleration signals illustrated in Graph 401.

The processor 120 may determine that a segment in which the SVM signal 420 and the gyro signal 430 are included within a predetermined threshold range for a predetermined time, or a segment in which a signal variation exists within an error range for a predetermined time is the first segment d in which there is no motion of the electronic device. For example, Graphs 402 and 403 in FIG. 4 may be used to determine a segment in which the SVM value and the gyro signal are included within a predetermined threshold range for a predetermined time, or the first segment d in which a signal variation exists within an error range for a predetermined time.

According to an embodiment, when the segment in which the SVM value and the gyro signal are included within the predetermined threshold range for the predetermined time, or the segment in which the signal variation exists within the error range for the predetermined time, corresponds to a long time that exceeds a preset threshold time, the processor 120 may divide the corresponding segment into predetermined units and may detect the first segment d for each divided segment.

When the first segment d is detected, the processor 120 may extract reference barometric pressure A and reference acceleration B information in the first segment d. As illustrated in Graph 404 of FIG. 4, the processor 120 may identify a barometric pressure sensor signal in the first segment d, extract a representative value of the identified barometric pressure sensor signal, and use the representative value as the reference barometric pressure A information. In addition, the processor 120 may identify an acceleration sensor signal in the first segment, and use a representative value of the identified acceleration sensor signal as the reference acceleration B information. For example, the representative value may be a median or a mean in each segment, but another value representing the segment may also be used.

For example, a portion of Graph 404 in FIG. 4 illustrates the change of a signal 450, where a representative barometric pressure value is extracted for the first segment d with no motion.

According to an embodiment, the processor 120 may also detect a first segment with no motion even in a situation where the user wearing the electronic device is walking. For example, ground contact time (GCT) refers to the time during which the foot of a user wearing an electronic device is in contact with the ground while the user is walking. Even when the electronic device recognizes that the user is walking, the electronic device may detect the GCT period to detect the first segment with no motion.

In operation 350, the processor 120 may determine whether a situation in which a fall or impact event occurs (or a situation requiring barometric pressure correction) is detected. For example, the processor 120 may detect a fall or impact event when the inertial sensor signal exceeds a predetermined threshold value or an impact equal to or greater than a predetermined level has occurred. In another example, the processor 120 may detect a situation requiring barometric pressure correction when an opposite movement situation, such as, a transition from the step-up to the step-down, occurs during stair movement or floor recognition based on the barometric pressure sensor signal.

In operation 360, after the fall or impact event occurs, the processor 120 may detect (or determine, identify), based on the inertial sensor signal, a second segment in which there is no motion of the electronic device, and may extract barometric pressure A′ and acceleration B′ information corresponding to the second segment.

The processor 120 may determine that a segment in which an SVM value and a gyro signal after the occurrence of the fall or impact event are included within a predetermined threshold range for a predetermined time, or a segment in which a signal variation exists within an error range for a predetermined time, is the second segment which there is no motion of the electronic device. The processor 120 may identify a barometric pressure sensor signal segment corresponding to the second segment, extract a representative value of the identified barometric pressure sensor segment, and use the representative value as the barometric pressure A′ information. The processor 120 may also identify an acceleration sensor signal segment corresponding to the second segment, and use a representative value of the identified acceleration signal segment as the acceleration B′ information.

In operation 370, the processor 120 may remodel the barometric pressure offset estimation model stored in the memory by using the reference barometric pressure A and reference acceleration B information extracted before the occurrence of the fall or impact event.

In operation 380, the processor 120 may apply barometric pressure A′ and acceleration B′ signals in a barometric pressure correction segment after the occurrence of the fall or impact event as inputs to the remodeled barometric pressure offset estimation model, thereby estimating (or predicting/calculation) a barometric pressure correction value (or an offset value). The barometric correction value (or the offset value) may be a value used to adjust the barometric pressure sensor's zero point, which is offset from zero and biased in the positive (+) or negative (−) direction, depending on the difference between a barometric pressure value measured by the barometric pressure sensor and a reference signal.

In operation 390, the processor 120 may acquire calibrated barometric pressure data by applying the estimated barometric pressure correction value C to an estimated barometric pressure A′ in the barometric pressure correction segment.

FIG. 5 illustrates a method of modeling a barometric pressure offset estimation model for an electronic device according to an embodiment.

Referring to FIG. 5, the electronic device 101 according to an embodiment may model and store a barometric pressure sensor offset estimation model when the electronic device is manufactured or configured.

In operation 510, the electronic device 101 may repeatedly collect acceleration and barometric pressure data for each posture of the electronic device 101. In operation 520, the electronic device 101 may derive a model between an independent variable x and a dependent variable y among the collected data and may measure the fitness. The independent variable x may refer to acceleration x-axis data, acceleration y-axis data, acceleration z-axis data, and barometric pressure data. The dependent variable y may refer to a barometric pressure correction value (or an offset value). In operation 530, the electronic device 101 may perform regression analysis based on the measurement of the fitness. In operation 540, the electronic device 101 may model a barometric pressure offset estimation model.

For example, the electronic device 101 may model a model that receives a barometric pressure and acceleration signals and predicts (or outputs, acquires) a barometric pressure correction value by using a mathematical expression for obtaining a parameter that minimizes the barometric pressure error.

Meanwhile, the method for modeling the barometric pressure offset estimation model may be understood as a known technique and may be replaced by a modeling method predictable by those skilled in the art.

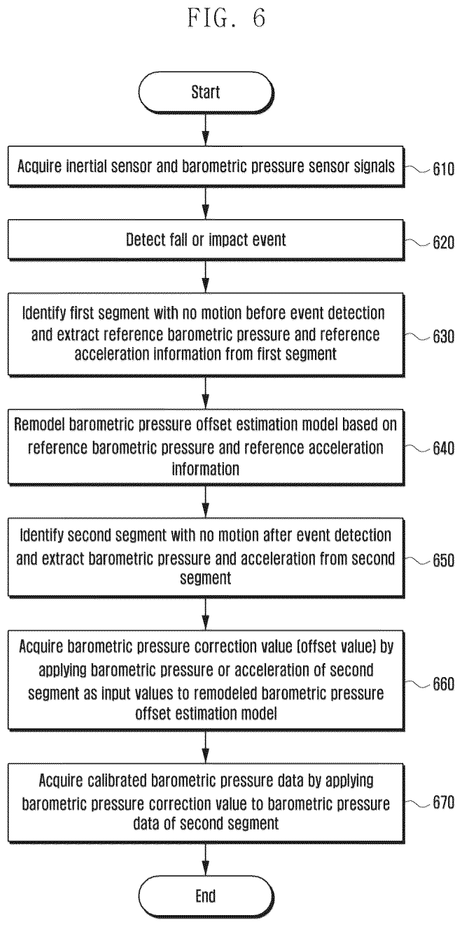

FIG. 6 illustrates a barometric pressure sensor data calibration method for an electronic device according to an embodiment.

In the following embodiments, operations may be performed sequentially, but are not necessarily performed sequentially. For example, the order of the operations may be changed, and at least two operations may be performed in parallel.

Referring to FIG. 6, in operation 610, the processor 120 of the electronic device 101 according to an embodiment may acquire a barometric pressure sensor signal from the barometric pressure sensor 220 and acquire an inertial sensor signal from the inertial sensor 230. The inertial sensor signal may include an acceleration signal and a gyro signal.

The processor 120 may store the barometric pressure sensor signal transmitted from the barometric pressure sensor 220 and the inertial sensor signal transmitted from the inertial sensor 230 in the memory 130.

In operation 620, the processor 120 may determine whether a fall or impact event (or a situation requiring pressure correction) is detected. For example, the processor 120 may detect a fall or impact event occurrence situation when the inertial sensor signal exceeds a predetermined threshold value or when an impact equal to or greater than a predetermined level has occurred.

In operation 630, the processor 120 may identify a first segment in which there was no motion of the electronic device before the event detection and may extract reference barometric pressure A and reference acceleration B information in the first segment.

According to an embodiment, the processor 120 may obtain a value of the magnitude of the sum (hereinafter, signal vector magnitude (SVM)) of the collected 3-axis (e.g., x-axis, y-axis, and z-axis) acceleration signals, and analyze an SVM signal and a gyro signal to detect the first segment. The processor 120 may determine that a segment in which the SVM signal 420 and the gyro signal 430 are included within a predetermined threshold range for a predetermined time, or a segment in which a signal variation exists within an error range for a predetermined time, is the first segment in which there is no motion of the electronic device. When the first segment is detected, the processor 120 may extract the reference barometric pressure A and reference acceleration B information in the first segment. For example, the processor 120 may identify a barometric pressure sensor signal corresponding to the first segment, extract a representative value of the identified barometric pressure sensor signal, and use the representative value as the reference barometric pressure A information. The processor 120 may also identify an acceleration sensor signal corresponding to the first segment, and use a representative value of the identified acceleration sensor signal as the reference acceleration B information.

According to an embodiment, the processor 120 may also detect the first segment with no motion even in a situation where a user wearing the electronic device is walking. For example, ground contact time (GCT) refers to the time during which the foot of a user wearing an electronic device is in contact with the ground while the user is walking. Even when the electronic device recognizes that the user is walking, the electronic device may detect the GCT period to detect the first segment with no motion.

In operation 640, the processor 120 may remodel a barometric pressure offset estimation model stored in the memory by using the reference barometric pressure A and reference acceleration B information extracted before the fall or impact event occurs.

In operation 650, the processor 120 may detect (or determine, identify) a second segment in which there is no motion of the electronic device after the detection of the fall event, and may extract barometric pressure A′ and acceleration B′ information corresponding to the second segment.

The processor 120 may determine that a segment in which an SVM value and the gyro signal after the occurrence of the fall or impact event are included within a predetermined threshold range for a predetermined time, or a segment in which a signal variation exists within an error range for a predetermined time, is the second segment in which there is no motion of the electronic device. The processor 120 may identify a barometric pressure sensor signal segment corresponding to the second segment, extract a representative value of the identified barometric pressure sensor segment, and use the representative value as the barometric pressure A′ information. In addition, the processor 120 may identify an acceleration sensor signal segment corresponding to the second segment, and use a representative value of the identified acceleration signal segment as the acceleration B′ information.

In operation 660, the processor 120 may estimate (or predict/calculate) a barometric pressure correction value (or an offset value) by applying barometric pressure A′ and acceleration B′ signals of a barometric pressure correction segment after the occurrence of the fall or impact event as inputs to the remodeled barometric pressure offset estimation model.

In operation 670, the processor 120 may acquire calibrated barometric pressure data by applying the estimated barometric pressure correction value C to a barometric pressure A′ in the second segment.

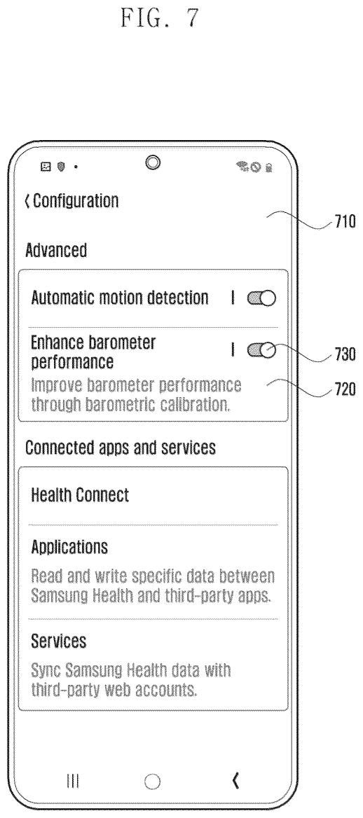

FIG. 7 illustrates a user interface screen related to barometric pressure sensor calibration in an electronic device according to an embodiment.

Referring to FIG. 7, an electronic device according to an embodiment may support the function of turning on or off the configuration of a barometric pressure sensor calibration function. For example, the electronic device may display a configuration screen 710 including a barometric pressure sensor calibration configuration menu 720. The barometric pressure sensor calibration configuration menu 720 may include a toggle item 730 for configuring whether or not to perform barometric pressure sensor calibration when an impact or fall event occurs. The user may use the toggle item 730 to configure the barometric pressure sensor calibration function or cancel the configuration of the barometric pressure sensor calibration function.

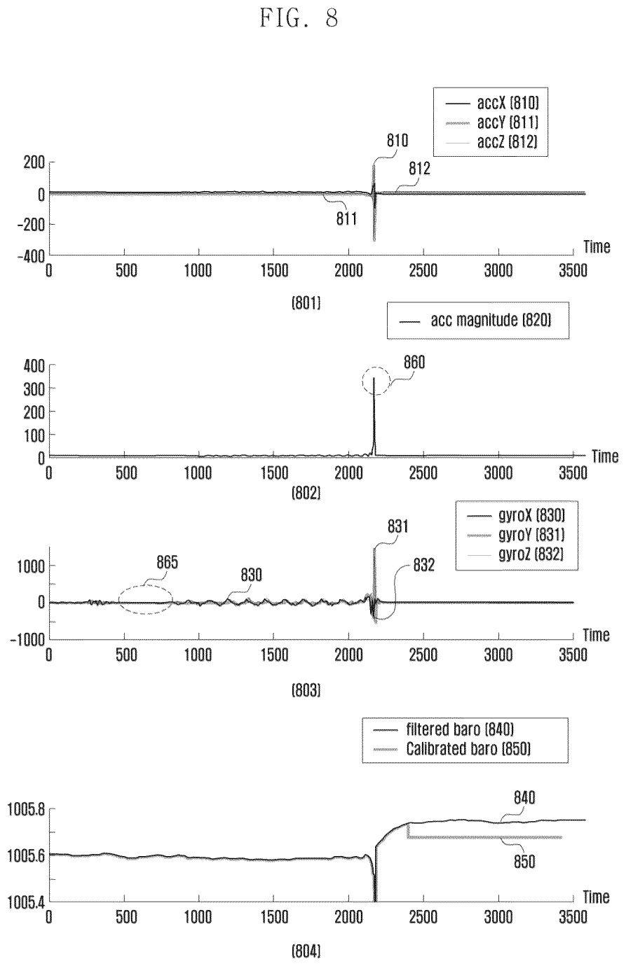

FIGS. 8 to 10 illustrate graphs of inertial sensor and barometric pressure sensor signals in various event situations according to various embodiments.

FIG. 8 illustrates changes in the inertial sensor and barometric pressure sensor signals in a situation where an impact event occurs while the user is walking on flat ground. Graph 801 shows the collected 3-axis (e.g., x-axis 810, y-axis 811, z-axis 812) acceleration signals, Graph 802 shows a signal vector magnitude (SVM) signal 820 of the 3-axis acceleration signals, Graph 803 shows a gyro signal 830, and Graph 804 shows a barometric pressure sensor signal 840 smoothed before calibration and a barometric pressure sensor signal 850 after calibration. The electronic device 101 may identify an impact occurrence time 860, based on the signal vector magnitude (SVM) signal 820 for the collected 3-axis (e.g., x-axis 810, y-axis 811, z-axis 812) acceleration signals and the gyro signal 830. Here, the impact occurrence time 860 may refer to the time at which a fall or impact event is detected. The electronic device 101 may identify a first segment 865 with no motion before the point of impact 860 and extract reference barometric pressure and reference acceleration in the first segment to remodel a barometric pressure offset estimation model. Subsequently, the electronic device 101 may calibrate barometric pressure data after the impact occurrence time 860 by using the remodeled barometric pressure offset estimation model. In the situation of FIG. 8, it was calculated that the user's altitude decreased by approximately 122.1 cm due to a fall. However, as illustrated in Graph 804, it can be seen that the barometric pressure sensor signal 580 after the barometric pressure calibration was predicted to have an altitude which decreased approximately 71.45 cm, compared to the barometric pressure sensor signal 840 before the calibration.

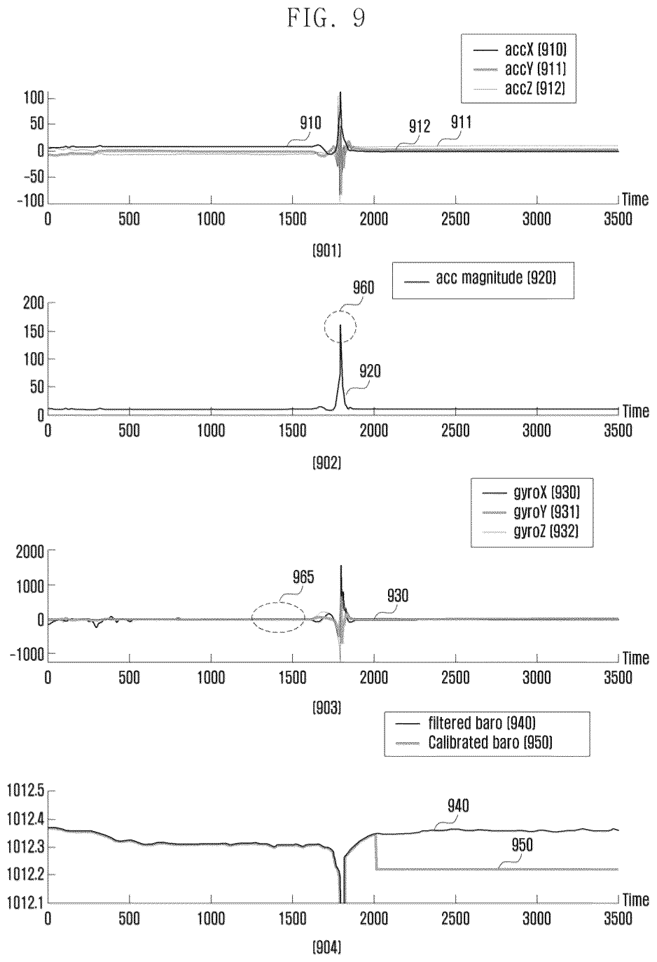

FIG. 9 illustrates changes in inertial sensor and barometric pressure sensor signals in a situation where a user wearing an electronic device performs a golf swing. Graph 901 shows collected 3-axis (e.g., x-axis 910, y-axis 911, and z-axis 912) acceleration signals, Graph 902 shows a signal vector magnitude (SVM) signal 920 for the 3-axis acceleration signals, Graph 903 shows a gyro signal 930, and Graph 904 shows a barometric pressure sensor signal 940 smoothed before calibration and a barometric pressure sensor signal 950 after calibration. The electronic device 101 may identify an impact occurrence time 960 (e.g., the time at which a fall or impact event is detected), based on the signal vector magnitude (SVM) signal 920 and the gyro signal 930. The electronic device 101 may identify a first segment 965 with no motion before the impact occurrence time 960, extract reference barometric pressure and reference acceleration in the first segment 965 to remodel a barometric pressure offset estimation model, and calibrate barometric pressure data after the impact occurrence time 960 by using the remodeled barometric pressure offset estimation model. In the event situation of FIG. 9, it can be seen that the barometric pressure sensor signal 940 before barometric pressure calibration is calculated to have an altitude which decreased by approximately 37.97 cm, while the barometric pressure sensor signal 950 after barometric pressure calibration was predicted to have an altitude which increased by approximately 68.8 cm.

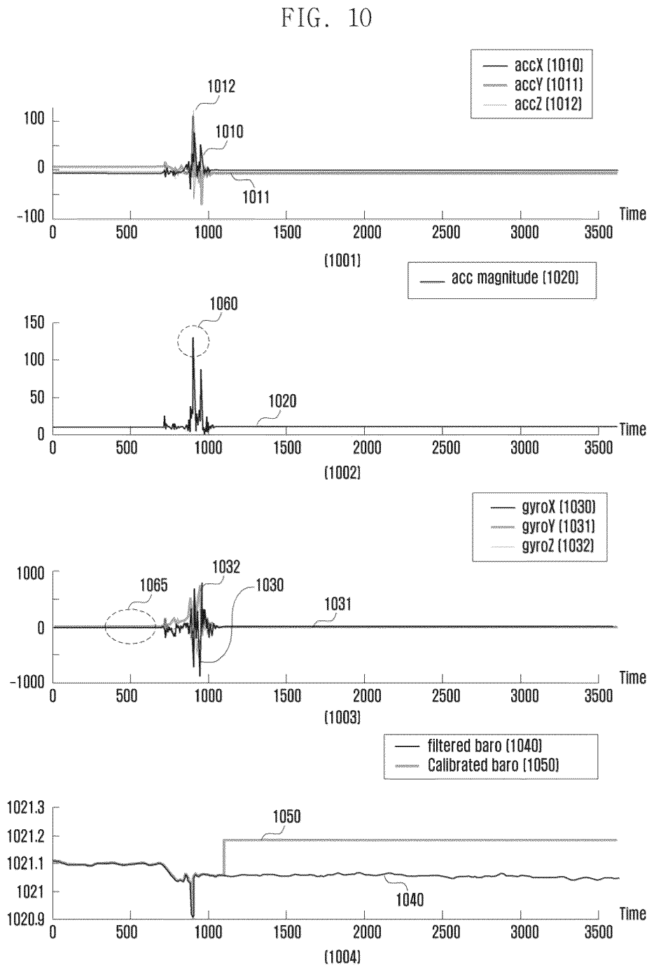

FIG. 10 illustrates changes in inertial sensor and barometric pressure sensor signals in a situation where a user wearing an electronic device falls from a bed. Graph 1001 shows collected 3-axis (e.g., x-axis 1010, y-axis 1011, and z-axis 1012) acceleration signals, Graph 1002 shows a signal vector magnitude (SVM) signal 1020 for the 3-axis acceleration signals, Graph 1003 shows a gyro signal 1030, and Graph 1004 shows a barometric pressure sensor signal 1040 smoothed before calibration and a barometric pressure sensor signal 1050 after calibration. The electronic device 101 may identify an impact occurrence time 1060 (e.g., the time at which a fall or impact event is detected), based on the signal vector magnitude (SVM) signal 1020 and the gyro signal 1030. The electronic device 101 may identify a first segment 1065 with no motion before the impact occurrence time 1060, extract reference barometric pressure and reference acceleration in the first segment 1065 to remodel a barometric pressure offset estimation model, and calibrate barometric pressure data after the impact occurrence time 1060 by using the remodeled barometric pressure offset estimation model. In the case of the event situation in FIG. 10, it can be seen that, despite the user falling from the bed, the barometric pressure sensor signal 1040 before barometric pressure calibration was calculated to have an altitude which increased by approximately 33.56 cm, whereas the barometric pressure sensor signal 1050 after barometric pressure calibration was predicted to have an altitude which decreased by approximately 57.65 cm.

According to various embodiments, by remodeling a barometric pressure offset estimation model using data before the occurrence of an event in various fall or impact event situations, and then performing barometric pressure sensor calibration, barometric pressure offset may be more accurately estimated, and barometric pressure data may be calibrated using the estimated barometric pressure offset.

In various embodiments, the barometric pressure offset estimation model may be remodeled for each fall or impact event, thereby preventing misrecognition in recognition operations (e.g., floor recognition algorithm/motion recognition algorithm) related to barometric pressure data and providing more accurate and various pieces of information to the user by utilizing refined barometric pressure data.

According to an embodiment, a barometric pressure sensor data calibration method for an electronic device including a barometric pressure sensor may include an operation of storing a barometric pressure offset estimation model according to the posture characteristics of the electronic device in a memory, an operation of acquiring a barometric pressure sensor signal from the barometric pressure sensor and an inertial sensor signal from the inertial sensor, an operation of, when a fall or impact event is detected based on the inertial sensor signal, identifying a first segment in which there is no motion of the electronic device in an inertial sensor signal before the detection of the fall or impact event, an operation of remodeling the barometric pressure offset estimation model stored in the memory, based on reference barometric pressure and reference acceleration extracted from the first segment, an operation of identifying a second segment in which there is no motion of the electronic device in an inertial sensor signal after the detection of the fall or impact event, an operation of estimating a barometric pressure correction value of the barometric pressure sensor by applying barometric pressure and acceleration extracted from the identified second segment as input values to the remodeled barometric pressure offset estimation model, and an operation of acquiring calibrated barometric pressure data by reflecting the barometric pressure correction value in a barometric pressure sensor signal after the detection of the fall or impact event.

According to an embodiment, the barometric pressure sensor may be a waterproof barometric pressure sensor having a sensing portion to which a waterproof gel is applied.

According to an embodiment, the inertial sensor data may include a 3-axis acceleration signal and a gyro signal, and the operation of identifying the first segment may further include an operation of detecting a fall or impact event occurrence situation when the inertial sensor signal exceeds a first predetermined threshold value or when an impact equal to or greater than a second predetermined level occurs, and an operation of determining that a segment in which a signal vector magnitude (SVM) signal of the 3-axis acceleration signal and the gyro signal are within a predetermined threshold range for a predetermined time, or a segment in which a signal variation exists within an error range for a predetermined time, is the first segment in which there is no motion of the electronic device.

According to an embodiment, the operation of remodeling the barometric pressure offset estimation model stored in the memory may further include an operation of applying a low-pass filter (LPF) to the acquired barometric pressure sensor signal to obtain a smoothed barometric pressure sensor, and an operation of extracting a representative value of the smoothed barometric pressure sensor signals and a representative value of acceleration signals within the first segment as the reference barometric pressure and the reference acceleration, respectively.

According to an embodiment, the operation of storing the barometric pressure offset estimation model in the memory may further include an operation of: repeatedly collect acceleration and barometric pressure data for each posture of the electronic device, and determine model fitness based on a relationship between collected independent and dependent variables, and based on the model fitness being confirmed, store the barometric pressure offset estimation model in the memory.

According to an embodiment, the operation of remodeling the barometric pressure offset estimation model may be characterized by remodeling the barometric pressure offset estimation model each time the fall or impact event is detected.

The electronic device may include a display. The processor may control the display to display an electronic device configuration screen including a barometric pressure sensor calibration configuration menu and a toggle item configured to turn on or off a barometric pressure sensor calibration.

According to an embodiment, a computer-readable recording medium recording a computer program for executing a barometric pressure sensor data calibration method of an electronic device including a barometric pressure sensor may include an operation of storing, in the memory, a barometric pressure offset estimation model according to the posture characteristics of the electronic device, an operation of acquiring a barometric pressure sensor signal from the barometric pressure sensor, an operation of acquiring an inertial sensor signal from an inertial sensor, an operation of identifying, when a fall or impact event is detected based on the inertial sensor signal, a first segment in which there is no motion of the electronic device in an inertial sensor signal before the detection of the fall or impact event, an operation of remodeling the barometric pressure offset estimation model stored in a memory, based on reference barometric pressure and reference acceleration extracted from the first segment, an operation of identifying a second segment in which there is no motion of the electronic device in an inertial sensor signal after the detection of the fall or impact event, an operation of estimating a barometric pressure correction value of the barometric pressure sensor by applying barometric pressure and acceleration extracted from the identified second segment as input values to the remodeled barometric pressure offset estimation model, and an operation of acquiring calibrated barometric pressure data by reflecting the barometric pressure correction value in a barometric pressure sensor signal after the detection of the fall or impact event.

According to an embodiment, the inertial sensor data may include a 3-axis acceleration signal and a gyro signal, and the computer program may further include an operation of detecting a fall or impact event occurrence situation when the inertial sensor signal exceeds a predetermined threshold value or when an impact equal to or greater than a predetermined level occurs, and determining that a segment in which a signal vector magnitude (SVM) signal of the 3-axis acceleration signal and the gyro signal are included within a predetermined threshold range for a first predetermined time, or a segment in which a signal variation exists within an error range for a second predetermined time, is the first segment in which there is no motion of the electronic device.

According to an embodiment, the computer program may further include an operation of extracting a representative value of barometric pressure sensor signals and a representative value of acceleration signals within the first segment as the reference barometric pressure and the reference acceleration, respectively.

According to an embodiment, the computer program may further include an operation of applying a low-pass filter (LPF) to the acquired barometric pressure sensor signal to obtain a smoothed barometric pressure sensor signal, and extracting a representative value of the barometric pressure sensor signals, based on the smoothed barometric pressure sensor signal.

According to an embodiment, the computer program may further include operations of: repeatedly collecting acceleration and barometric pressure data for each posture of the electronic device, determining model fitness based on a relationship between collected independent and dependent variables; and storing the modeled barometric pressure offset estimation model in the memory.

In one or more embodiments, an electronic apparatus may include: a motion sensor configured to generate motion data; a waterproof pressure sensor configured to generate atmospheric pressure data; a memory storing a pressure offset estimation model associated with orientations of the electronic apparatus; and a processor communicatively coupled to the memory, the motion sensor, and the waterproof pressure sensor, wherein the processor is configured to: monitor the motion data to detect a trigger event representing a physical impact; determine a pre-event stationary window from the motion data occurring prior to the trigger event; update the pressure offset estimation model stored in the memory based on a baseline pressure value and a baseline orientation value obtained from the pre-event stationary window; determine a post-event stationary window from the motion data occurring after the trigger event; calculate a correction factor by inputting pressure and orientation values obtained from the post-event stationary window into the updated pressure offset estimation model; and generate compensated pressure information by applying the correction factor to pressure data captured subsequent to the trigger event.

The sensor may include a 3-axis accelerometer and a gyroscope, and the processor is further configured to: identify the pre-event stationary window by detecting a period where a signal vector magnitude (SVM) of the 3-axis accelerometer and data from the gyroscope remain within a predefined threshold for a specific duration; and calculate the baseline pressure value and the baseline orientation value by extracting representative statistical values from the data captured during said pre-event stationary window.

The processor may be further configured to: apply a low-pass filter (LPF) to the atmospheric pressure data to generate a smoothed pressure signal prior to extracting values for the pressure offset estimation model; and generate an initial version of the pressure offset estimation model by iteratively collecting orientation and pressure data across a plurality of postures of the electronic apparatus and performing a regression analysis to determine fitness between independent orientation variables and dependent pressure offset variables.

The waterproof pressure sensor may include a sensing portion encapsulated in a waterproof gel susceptible to gravity-induced pressure shifts; and the electronic apparatus may include a display configured to provide a graphical user interface (GUI) including a calibration settings menu and a toggle element allowing a user to selectively enable or disable calibration of the waterproof pressure sensor.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
an inertial sensor;
a barometric pressure sensor;
memory comprising instructions; and
a processor operatively connected to the inertial sensor, the barometric pressure sensor, and the memory, wherein the instructions, when executed by the processor, cause the electronic device to:
store, in the memory, a barometric pressure offset estimation model according to posture characteristics of the electronic device,
acquire a barometric pressure sensor signal from the barometric pressure sensor and acquire an inertial sensor signal from the inertial sensor,
based on a fall or impact event being detected from the inertial sensor signal, identify a first segment in which there is no motion of the electronic device in an inertial sensor signal before the fall or impact event is detected,
remodel the barometric pressure offset estimation model stored in the memory, based on reference barometric pressure and reference acceleration extracted from the first segment,
identify a second segment in which there is no motion of the electronic device in an inertial sensor signal after the fall or impact event is detected,
estimate a barometric pressure correction value of the barometric pressure sensor by applying barometric pressure and acceleration extracted from the identified second segment as input values to the remodeled barometric pressure offset estimation model, and
acquire calibrated barometric pressure data by reflecting the barometric pressure correction value in the barometric pressure sensor signal after the fall or impact event is detected.

2. The electronic device of claim 1, wherein the barometric pressure sensor is a waterproof barometric pressure sensor having a sensing portion coated with a waterproof gel.

3. The electronic device of claim 1, wherein the instructions, when executed by the processor, cause the electronic device to:
detect an occurrence situation of the fall or impact event based on the inertial sensor signal exceeding a predetermined threshold value.

4. The electronic device of claim 1, wherein the inertial sensor signal comprises a 3-axis acceleration signal and a gyro signal, and
wherein the instructions, when executed by the processor, cause the electronic device to:
determine, as the first segment in which there is no motion of the electronic device, a segment in which a signal vector magnitude (SVM) signal of the 3-axis acceleration signal and the gyro signal fall within a predetermined threshold range for a first predetermined period of time, or a segment in which a signal variation is within an error range for a second predetermined period of time.

5. The electronic device of claim 4, wherein the instructions, when executed by the processor, cause the electronic device to:
extract, as the reference barometric pressure and the reference acceleration, a representative value of barometric pressure sensor signals and a representative value of acceleration signals within the first segment, respectively.

6. The electronic device of claim 5, wherein the instructions, when executed by the processor, cause the electronic device to:
apply a low-pass filter (LPF) to the acquired barometric pressure sensor signal to obtain a smoothed barometric pressure sensor signal, and
extract the representative value of the barometric pressure sensor signals, based on the smoothed barometric pressure sensor signal.

7. The electronic device of claim 6, wherein the instructions, when executed by the processor, cause the electronic device to:
repeatedly collect acceleration and barometric pressure data for each posture of the electronic device;
determine model fitness based on a relationship between collected independent and dependent variables, and
based on the model fitness being confirmed, store the barometric pressure offset estimation model in the memory.

8. The electronic device of claim 1, wherein the instructions, when executed by the processor, cause the electronic device to:
remodel the barometric pressure offset estimation model each time the fall or impact event is detected.

9. The electronic device of claim 1, further comprising a display,
wherein the instructions, when executed by the processor, cause the electronic device to:
control the display to display an electronic device configuration screen including a barometric pressure sensor calibration configuration menu and a toggle item configured to turn on or off a barometric pressure sensor calibration.

10. A barometric pressure sensor data calibration method performed by an electronic device comprising a barometric pressure sensor and an inertial sensor, the method comprising:
storing, in a memory, a barometric pressure offset estimation model according to posture characteristics of the electronic device;
acquiring a barometric pressure sensor signal from the barometric pressure sensor and acquiring an inertial sensor signal from the inertial sensor;
based on a fall or impact event being detected from the inertial sensor signal, identifying a first segment in which there is no motion of the electronic device in an inertial sensor signal before the fall or impact event is detected;
remodeling the barometric pressure offset estimation model stored in the memory, based on reference barometric pressure and reference acceleration extracted from the first segment;
identifying a second segment in which there is no motion of the electronic device in an inertial sensor signal after the fall or impact event is detected;
estimating a barometric pressure correction value of the barometric pressure sensor by applying barometric pressure and acceleration extracted from the identified second segment as input values to the remodeled barometric pressure offset estimation model; and
acquiring calibrated barometric pressure data by reflecting the barometric pressure correction value in the barometric pressure sensor signal after the fall or impact event is detected.

11. The method of claim 10, wherein the barometric pressure sensor is a waterproof barometric pressure sensor having a sensing portion coated with a waterproof gel.

12. The method of claim 10, wherein the inertial sensor signal comprises a 3-axis acceleration signal and a gyro signal, and
wherein the identifying of the first segment further comprises:
detecting an occurrence situation of a fall or impact event based on the inertial sensor signal exceeding a predetermined threshold value or an impact equal to or greater than a predetermined level occurs; and
determining, as the first segment in which there is no motion of the electronic device, a segment in which a signal vector magnitude (SVM) signal of the 3-axis acceleration signal and the gyro signal fall within a predetermined threshold range for a first predetermined period of time, or a segment in which a signal variation is within an error range for a second predetermined period of time.

13. The method of claim 10, wherein the remodeling of the barometric pressure offset estimation model stored in the memory further comprises:
applying a low-pass filter (LPF) to the acquired barometric pressure sensor signal to obtain a smoothed barometric pressure sensor signal; and
extracting, as the reference barometric pressure and the reference acceleration, a representative value of the smoothed barometric pressure sensor signals and a representative value of acceleration signals within the first segment, respectively.

14. The method of claim 10, wherein the storing of the barometric pressure offset estimation model in the memory further comprises
repeatedly collecting acceleration and barometric pressure data for each posture of the electronic device, and determining model fitness based on a relationship between collected independent and dependent variables.

15. The method of claim 10, wherein the remodeling of the barometric pressure offset estimation model comprises remodeling the barometric pressure offset estimation model each time the fall or impact event is detected.

16. An electronic apparatus comprising:
a motion sensor configured to generate motion data;
a waterproof pressure sensor configured to generate atmospheric pressure data;
memory storing instructions and a pressure offset estimation model associated with orientations of the electronic apparatus; and
a processor communicatively coupled to the memory, the motion sensor, and the waterproof pressure sensor, wherein the instructions, when executed by the processor, cause the electronic apparatus to:
monitor the motion data to detect a trigger event representing a physical impact;
determine a pre-event stationary window from the motion data occurring prior to the trigger event;
update the pressure offset estimation model stored in the memory based on a baseline pressure value and a baseline orientation value obtained from the pre-event stationary window;
determine a post-event stationary window from the motion data occurring after the trigger event;
calculate a correction factor by inputting pressure and orientation values obtained from the post-event stationary window into the updated pressure offset estimation model; and
generate compensated pressure information by applying the correction factor to pressure data captured subsequent to the trigger event.

17. The electronic apparatus of claim 16, wherein the motion sensor comprises a 3-axis accelerometer and a gyroscope, and the instructions, when executed by the processor, cause the electronic apparatus to:
identify the pre-event stationary window by detecting a period where a signal vector magnitude (SVM) of the 3-axis accelerometer and data from the gyroscope remain within a predefined threshold for a specific duration; and
calculate the baseline pressure value and the baseline orientation value by extracting representative statistical values from the data captured during said pre-event stationary window.

18. The electronic apparatus of claim 16, wherein the instructions, when executed by the processor, cause the electronic apparatus to:
apply a low-pass filter (LPF) to the atmospheric pressure data to generate a smoothed pressure signal prior to extracting values for the pressure offset estimation model; and
generate an initial version of the pressure offset estimation model by iteratively collecting orientation and pressure data across a plurality of postures of the electronic apparatus and performing a regression analysis to determine fitness between independent orientation variables and dependent pressure offset variables.

19. The electronic apparatus of claim 16, wherein:
the waterproof pressure sensor comprises a sensing portion encapsulated in a waterproof gel susceptible to gravity-induced pressure shifts; and
the electronic apparatus further comprises a display configured to provide a graphical user interface (GUI) including a calibration settings menu and a toggle element allowing a user to selectively enable or disable calibration of the waterproof pressure sensor.

20. The electronic apparatus of claim 16, wherein the instructions, when executed by the processor, cause the electronic apparatus to:
update the pressure offset estimation model each time the trigger event is detected, to dynamically reflect a physical change of the waterproof pressure sensor.
